(19) United States
(12) Patent Application Publication
(10) Pub. No.: US 2022/0060139 A1
(43) Pub. Date: Feb. 24, 2022

(54) PHOTOVOLTAIC MODULE FASTENING SYSTEMS

(71) Applicant: Erthos IP LLC, Tempe, AZ (US)

(72) Inventors: Michael GLADKIN, Tempe, AZ (US); Willam HAMMACK, Tempe, AZ (US); James Scott Tyler, Tempe, AZ (US)

(21) Appl. No.: 17/316,535

(22) Filed: May 10, 2021

Related U.S. Application Data
(60) Provisional application No. 63/021,928, filed on May 8, 2020.

(51) Int. Cl. H02S 20/10; H02S 30/10

(52) U.S. Cl. CPC H02S 20/10; H02S 30/10

(57) ABSTRACT

A PV module alignment or attachment system and method that contains a root cable that interacts with the modules along rows or columns of an array of the modules. In some versions, the cable passes through frames of the modules in a row or column and maintains the module-to-module height between modules. The cable need not be metallic. In some versions, the cable passes through clips attached to the module substrate directly or to module frame members.

### CROSS-REFERENCE TO RELATED APPLICATIONS

This application is related to and claims priority to U.S. Provisional Patent Application No. 63/021,928, filed on May 8, 2020. The entire content of the application is incorporated by this reference.

### BACKGROUND

### Technical Field

The disclosed technology relates to the mounting of solar panels using a terrestrial or ground-based mounting system.

### Background Art

Solar panels or modules are assemblies of multiple photovoltaic (PV) cells hardwired to form a single unit, typically as a rigid piece. Flexible solar panels are known, as well. Multiple solar panels form an array with strings of panels wired together in series. These strings connect to a power receiving unit, typically an inverter or other controller, that provides an initial power output. One or more solar arrays form a solar plant.

A silicon-based PV module, also commonly called crystalline silicon (c-Si) PV module, is a packaged, connected assembly of typically 6×12 photovoltaic solar cells. But this can vary according to design choice. Other types of PV cell technology include “thin-film” and variations of silicon-based technology. Two thin-film module technologies stand out. The first is CdTe (Cadmium Tellurium), also known as CadTel. The second is CIGS or CIS (Copper, Indium, Gallium, Selenium or Copper, Indium, Selenium).

The number of panels making up a string can vary. Strings can contain 17-29 panels in typical applications depending on both the environmental condition and the module's rated voltage (string voltage). The row size of panels in a row of Single Axis Tracker (SAT) and Fixed Tilt (FT) systems can vary and a typical row is three (3) strings of 26-28 panels per row for SAT systems summing to between 76-84 panels per row. A single row is limited by geographical grade changes within the span of the row and rigid structural limitations based on the typical steel structure. Multiple rows of solar panels make up an array of solar panels. The array size is limited by power transmission limitations, including limiting maximum voltage and current at the Power Conversion Station and Medium Voltage Step Up Transformer. The panels within an array may be connected in one or more series or parallel strings. A series string is a set of panels series connected to increase voltage typically limited to 1500V DC per string for a Utility Scale Solar System. Arrays are often divided into multiple strings of equal voltage connected in parallel to sum the current. This arrangement limits the maximum voltage output of a string and the maximum current output of an array.

Thus, solar cells internally connect within a panel. And panels connect within a string. Multiple strings connect within a row. Multiple rows form an array that feeds into an inverter or inverters either directly or through wiring harnesses. Multiple inverters are connected to further output circuitry commonly MV Transformers, which are connected to transmission circuitry. The strings are connected either directly or through wiring harness connections to the inverter.

The goal is to reduce the Levelized cost of energy (LCOE) for the PV power plants. The utility-scale PV power plant is unique from the many other solar power and electricity production forms. Due to the size, energy cost, safety regulations, and operating requirements of utility-scale power production, the components, hardware design, construction means and methods, and operations and maintenance all have specific, unique features yielding the designation “utility-scale” typically at 1000V or 1500V DC generation sizing.

Since its inception, PV technology has been an expensive solution for power production. The PV cells within the heart of the solar modules have been very expensive to manufacture and inefficient. Over the past 40 years, significant strides have been made on PV cell and module manufacturing and technology fronts. These improvements have brought PV electricity costs below the more traditional utility-scale power generation methods in some geographical regions.

Today two main industry adopted technologies, Fixed Tilt (FT) racking and Single-Axis Tracking SAT, are commonly utilized as an industry standard structural means to securing the solar panels to orient them to the sun and optimize the solar panel efficiency and increase energy production to lower the cost of electricity of the solar system. Fixed Tilt racking and Single-Axis Trackers are rigid mounting systems, typically made of structural steel, and are expensive to install and maintain.

Fixed Tilt and Single-Axis Tracking methods are often categorized as “ground mount” technologies, which separates them from roof-mount technologies. “Ground Mount” means that the modules are supported by free-standing structures with dedicated foundations rather than buildings. Ground Mount technologies typically have the leading edge of the modules 1 ft or greater above finished grade and the high edge or trailing edge of the modules extending 10 ft or greater above finished grade. Steel-pile reveal height for the structural racking is commonly 5 ft above grade with maximum and minimum being 3 ft-7 ft commonly depending on configuration. Typical row spacing for rows of solar panels is 15-21 ft due to the tilt angle of the modules and to prevent row to row shading.

When deployed in large solar farms, solar panels are typically mounted on racks that orient the panels toward the Sun. With gimballed racks, called trackers, the panel is pivoted to face the Sun throughout the day by tracking the sun, with some systems also accounting for solar elevation or otherwise account for the Sun's effect analemma. Fixed racking and tracking of PV modules increases efficiency of the solar modules by better aligning the modules to the sunlight through optimization of the solar incidence angle. Rows of FT or SAT plants are commonly spaced at 15-21 ft row spacing to avoid shading from row to row throughout the day.

Generally, the nature of solar cells is such that they are generally waterproof and durable. For example, it is common for solar modules to be tested and certified to withstand hail of up to 25 mm (one inch) falling at about 23 m/sec (51 mph). While it is possible to clean solar panels, as a practical matter, racked solar panels are not frequently cleaned because the expense is not justified by expected energy loss resulting from dirt and dust accumulation. For example, in Southern California, the estimated energy loss from dirt and dust is approximately 5%/year, but if the panels were cleaned, the loss would approximate 1%/year.

One consideration in mounting solar panels on racks or trackers is the albedo effect, resulting from sunlight reflecting from the ground, resulting in backside heating. This issue is addressed in various ways by coating the backside of the solar panels with a white coating. A disadvantage of doing that is that white coatings slow heat discharge through the module's backside. Today's industry is commonly now deploying bi-facial solar panels to extract additional energy from the solar panel in a FT or SAT configuration.

In typical configurations, the array output voltage (series voltage of the panels in a string) is 1500 volts. Solar arrays are limited in voltage due to solar panel manufacturing maximum voltage limits, the National Electric Code, and International Electric Code. To limit the voltage, panels are arranged in groups called strings that connect to the inverter through harnesses. The strings' physical arrangement on the trackers or racks requires harnessing equipment. In a typical tracker system, three sets of strings are used on a single tracker assembly. To connect those strings to the inverter, harnesses of varying configurations are used, although this number can change according to the rack's length and other considerations.

The harnesses themselves are a significant cost factor. Since the system is voltage-limited, the total power output of the plant translates to substantial wiring costs for harness systems. Similarly, power losses through the wiring harness translate to additional costs. Therefore, it is desired to provide a physical configuration of solar panels, rows, and arrays that reduces the length of cable runs in connection harnesses.

One wiring harness configuration used with racked modules is called “skip stringing” or “leapfrog wiring”. In skip stringing, wiring harnesses bypass alternate panels to provide efficient wiring by limiting cabling to approximately the distance between alternating modules. The ability to achieve connections extending over a longer distance without a proportional increase in cabling allows positive and negative connections to be placed closer to the inverter, reducing the number of harness conductors needed to connect to the inverter. Since the panels are alternately connected, the alternate panels within the same physical row can provide a return circuit, reducing the distance between an end panel and the inverter. Ideally, one positive or negative pole connection for connecting the string to the inverter is only one panel away from the other pole connection. This reduces the length of the “home run” wire but requires each link to skip alternate panels to return along the same row.

While it would be possible to string panels across two or more rows, it would shorten the rows and increase costs. Skip stringing wiring is used because, by skipping adjacent panels, the length of a string is maintained while providing for a return connection along the same row. This arrangement effectively doubles the length of a string over the length that would exist if the string were extended across two rows.

This stringing system accommodates the panels' polarities; however, this technique still requires wiring harnesses in the connection. In addition, these techniques still require additional harnesses to connect between the respective ends of the strings and the inverter. Since adjacent rows of panels are separated by a space corresponding to the cast shadow of racked panels, it becomes impractical to string panels across rows.

Another issue involving racked or tracker-mounted solar panels is the effect of wind. Dependent upon installation location, the wind speed can vary from 85-140 mph in the USA. High wind forces, which can reach hurricane force strength, often preclude the construction of solar power plants in those regions or increase the expense by requiring very robust structural steel with deep foundations and large cross-sectional areas for foundations as the mean wind force resisting system. In addition, the modules themselves are easily damaged by high winds requiring significant repair and replacement expenditures due to cyclic loading on the structure with the modules tilted like sails in the wind as they are fixed above finished grade. Besides apparent damage resulting from the direct forces of wind, the adverse effects of cyclic loading can cause “micro-cracking”. This “micro-cracking” damage occurs over time, causing accelerated degradation rates of the module cells. This micro-cracking has become a serious issue for the industry influencing long-term module warranties.

Another issue involving racked or tracker-mounted solar panels is environmental corrosion due to corrosive soils and corrosive air such as salt spray. Typical ground-mount power plants use driven steel piles sized to counter the effects of wind loading on the overall structure. Pile sizing is determined by geotechnical corrosion test results and structural loading requirements to resist wind loading for the area. Pile sizing must account for the corrosion of the steel or other materials and still be able to last for 25 years. The more corrosive the soil, the thicker the posts will be designed and used as sacrificial steel to ensure a 25-year life. Similar issues exist for geographies near the oceans where salt spray environments exist.

### SUMMARY

The Erthos Earth Mount System mounts the solar panels directly to the earth without an intermediate structure between the modules and the earth itself. The Root Cable creates a mesh network of flexible mechanical connection between adjacent solar modules, strings of modules, and rows of modules making up a larger array. The root cable and finished grade both align the modules in the X, Y, Z axes creating a meshed array of modules through the wire rope network limiting the modules from being able to escape from the mesh. The nature and location of alignment holes in the frame allow the system to align the faces of a solar module with its surrounding modules. The flexible mechanical connection allows modules to contour to the grade changes of the earth and will help to prevent damage to the modules from differential settlement of soils that may occur over time within the array boundary.

The Root Cable results in a meshed array where every solar module is directly or indirectly connected to all other modules in the array through the wire rope network while root cable limits the total vertical or horizontal shift that may occur through module expansion, contraction, and differential soil settlement that may occur over time. The modules are constrained yet free floating within their array boundaries.

The arrangement of modules strung together with the root cable creates essentially a zero module to module row spacing requirement as there will be no shading throughout the array due to the limited vertical height differential from module to module. Additionally, the root cable creates an array interior of modules with no parts or pieces to penetrate the Earth's surface inside of the array. The interconnected mesh network of modules resists uplift forces through the combined weight of the solar array and its leading edge resulting in a flexible and abatable anchoring system. Flexible mechanical connections enable the array to follow the Earth's natural contour. Wire rope is made of corrosion resistant materials and hidden beneath the solar panel surfaces.

This disclosure covers a system for a PV module alignment or attachment system and a method of preparing PV module arrays. Some uses for these arrays is for use in utility-scale solar PV plants. The system contains a root cable that interacts with the modules along rows or columns of an array of the modules. The method for producing the array has various steps including supplying the PV modules; and arranging the modules into an array in an earth mount configuration on the surface at a site of the plant or on an earth surface. The modules and root cable follows the contour of the ground. These cables maintain a module-to-module edge alignment. In some versions, the cables maintain the modules such that an autonomous cleaning robot can traverse from module to module. The cables interact with the modules through a penetration in the module or a module clip that sometimes contains a similar penetration. The array may comprise rows of greater than 25 or 50 modules and columns having greater than 6, 17, 14, 29, or 50 modules. In some versions, the root cable lays diagonally across the array region.

In some versions, the array is lined on at least one side by leading edges.

In some versions, the root cable may be anchored at an end of, both ends of, one or more midpoints along, or one or more midpoints along and one or both ends of the root cable.

### BRIEF DESCRIPTION OF THE FIGURES

FIG. 1 is a perspective view of a PV module with a root cable.

FIG. 2 is another perspective view of a PV module with a root cable.

FIG. 3 is a magnified cross-section view of the PV module of FIG. 1.

FIG. 4 is a side view of a PV module with a root cable.

FIG. 5 side cross-sectional view of the PV module of FIG. 4.

FIG. 6 is a perspective view of a PV module with a root cable.

FIG. 7 is a schematic side view of a string of PV modules with a root cable.

FIG. 8 is a magnified view of a connection between the PV modules of FIG. 7.

FIG. 9 is a magnified view of a connection between the modules of FIG. 7

FIG. 10 is a schematic view of a leading edge of a PV module array with a root cable system.

FIG. 11 is a cross-section of FIG. 10.

FIG. 12 perspective view of a PV array.

FIG. 13 is a magnified view of FIG. 12.

FIG. 14 is a side view of the PV module showing one type of opening for a root cable.

FIG. 15 is a magnified view of FIG. 14.

FIG. 16 is a side view of the PV module showing a root cable.

FIG. 17 is a perspective view of the PV module showing the opening of FIG. 14.

### DETAILED DESCRIPTION

Unless defined otherwise, all technical and scientific terms used in this document have the same meanings as commonly understood by one skilled in the art to which the disclosed invention pertains. Singular forms—a, an, and the—include plural referents unless the context indicates otherwise. Thus, reference to “fluid” refers to one or more fluids, such as two or more fluids, three or more fluids, etc. When an aspect is to include a list of components, the list is representative. If the component choice is limited explicitly to the list, the disclosure will say so. Listing components acknowledges that exemplars exist for each component and any combination of the components—including combinations that specifically exclude any one or any combination of the listed components. For example, “component A is chosen from A, B, or C” discloses exemplars with A, B, C, AB, AC, BC, and ABC. It also discloses (AB but not C), (AC but not B), and (BC but not A) as exemplars, for example. Combinations that one of ordinary skill in the art knows to be incompatible with each other or with the components' function in the invention are excluded, in some exemplars.

When an element or layer is called being “on”, “engaged to”, “connected to” or “coupled to” another element or layer, it may be directly on, engaged, connected, or coupled to the other element or layer, or intervening elements or layers may be present. When an element is called being “directly on”, “directly engaged to”, “directly connected to”, or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.).

Although the terms first, second, third, etc., may describe various elements, components, regions, layers, or sections, these elements, components, regions, layers, or sections should not be limited by these terms. These terms may distinguish only one element, component, region, layer, or section from another region, layer, or section. Terms such as “first”, “second”, and other numerical terms do not imply a sequence or order unless indicated by the context. Thus, a first element, component, region, layer, or section discussed below could be termed a second element, component, region, layer, or section without departing from this disclosure.

Spatially relative terms, such as “inner”, “outer”, “beneath”, “below”, “lower”, “above”, “upper” may be used for ease of description to describe one element or feature's relationship to another element or feature as illustrated in the figures. Spatially relative terms may be intended to encompass different orientations of the device in use or operation besides the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors interpreted.

The description of the exemplars has been provided for illustration and description. It is not intended to be exhaustive or to limit the invention. Individual elements or features of a particular exemplar are not limited to that exemplar but, where applicable, are interchangeable and can be used in a selected exemplar, even if not explicitly shown or described. The same may also be varied. Such variations are not a departure from the invention, and all such modifications are included within the invention's scope.

Technology

The disclosed technology provides a technique for generating electricity using commercially available utility-scale PV (e.g., CSi, CdTe, CIGS, CIS) modules, new and novel adaptations of these modules, or new module technologies. A group of modules is mounted in direct contact and parallel with the Earth's surface. This mounting establishes an earth orientation of the PV modules, as distinguished from a solar orientation. But contouring of the soil and other mounting considerations will account for the Sun's angle, in some exemplars.

The modules are tiled into a grid pattern edge to edge and end to end. This technology does not limit how the modules attach to one another or to the Earth. This arrangement of modules substantially reduces the wind loading effects of the modules. The electrical arrangement of the modules allows for both series and parallel connections and eliminates, but does not preclude, the need for discrete wiring harnesses and harness supporting means used by traditional utility-scale solar plant PV power plant systems. This module arrangement provides significant advantages when used with string or microinverters but is equally suitable for industry-standard central inverters or alternate power conversion and transmission technologies.

Modules using prior art conductive module-support structures require module bonding and grounding to meet code.

This module arrangement dispenses with steel and steel structures in the power plant and their corrosion while increasing power plant life sometimes to greater than 40 years. But steel, coated or otherwise, may be used with these systems.

The arrangement of modules allows for both commercially available and new techniques for module cleaning and dust removal, increasing the effective energy production rate.

The module arrangement reduces high wind (sometimes hurricane strength) forces on the modules, which increases the cost of or often precludes construction of solar power plants in high-wind regions. Since high winds easily damage the modules, removing them from high winds reduces repair and replacement costs.

This technology allows for module cooling methods such as evaporative cooling, applying high emissivity coatings, adding “air vents” on module edges, adding heat transfer materials, or using heat transfer methods, increasing the modules' energy production rates. Ground positioning avoids module heating from indirect sunlight and sunlight-heated ground. This positioning transforms the ground from being a heat source to being a heat sink.

The disclosed technology increases the power density per acre of land. The quantity of acres used per unit of power production is reduced by over 50% from traditional utility-scale solar plant PV power plants. This technology eliminates row to row spacing as required to prevent shading of rows of modules.

Since the disclosed technology allows the PV array to follow existing land contours, the typical need for mass grading, plowing, tilling, cutting, and filling within arrays can be reduced or eliminated.

While not tracking the Sun reduces module performance, the overall cost savings from reduced electrical losses in wiring, removal of the structural steel racking system, energy increases from increase module cleaning, reduced material cost, and reduced construction schedule and risk costs yields a reduced produced energy price (LCOE) of greater than 10% over current technologies.

This adjacent positioning allows wiring connections or harnesses to take advantage of the adjacent relationships across two or more rows, reducing the need for harness connections. In a particular arrangement, module to module string connection distances, are reduced because adjacent rows can be connected without “skip stringing” or “leapfrog wiring”. DC Homerun connections commonly called “whips” are reduced due to the elimination of row-to-row spacing requirements. In an alternate arrangement, sequential connections can be made with “next” panels in adjacent rows, reducing the length of connections required for “skip stringing” or “leapfrog wiring”.

Eliminating structural racking affords an additional advantage with wire harnessing. Since there are no racks, there is no need to consider racks and associated wire management when designing wire harnesses. Thus, module strings can terminate at both ends of the strings close to the inverters. Multiple strings closely terminating allows inverter positioning close to string end terminations.

Root Cable System
5 PV frame perimeter
9 PV frame
10 short-side
20 long-side
21 PV module surface

30 cable crossing

39 root cable

40 long root cable

50 short root cable

59 root cable penetration

60 short-end cable opening or penetration

70 long-side cable opening or penetration

80 leading edge

90 leading-edge cable opening or penetration

100 uplift

101 keyhole slot

110 outer vertical slot

111 inner vertical slot

120 horizontal slot

125 cable stop

410 inner wall

420 outer wall

430 downward gap

440 upward gap

500 earth or ground

910 bushing

915 ridge or head

916 body

931 entry

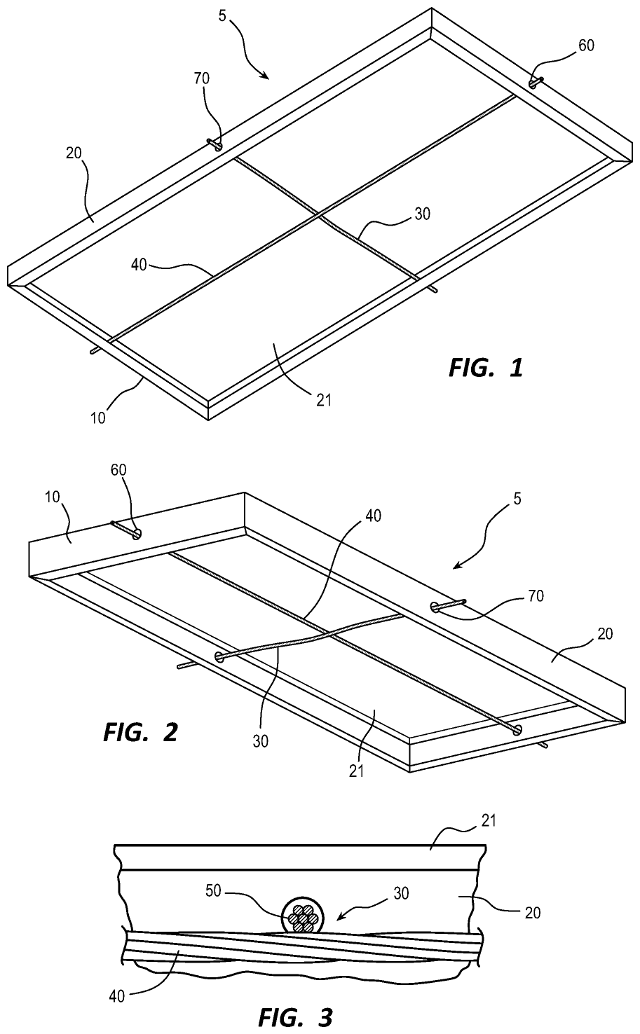

FIG. 1 shows a perspective view of a PV module 4 comprising a PV module frame perimeter 5 having short-side 10 and long-side 20. In some exemplars, short-side 10 and long-side 20 have the same length. FIG. 1 also shows the underside of PV substrate 21. Long root cable 40 is shown in the figure and extends along PV module 4 in the long direction of the module for the entire length of the PV module row or column. Long root cable 40 corresponds to the long direction of the individual PV module, not necessarily the long direction of the PV module row, column, or array. Short root cable 50 is like long root cable 40 except that it extends along the short direction of PV module 4. Crossover 30 is the position where long root cable 40 and short root cable 50 Cross each other. FIG. 2 is a magnified view of crossover 30 in cross-section. The cross-section cut is parallel to long root cable 40 offset from crossover 30. Therefore, short root cable 50 is shown in cross-section.

FIG. 3 is a perspective view of PV module 4 from a different angle than FIG. 1. It shows root cable openings or penetrations: short-side penetration 60 and long-side penetration 70.

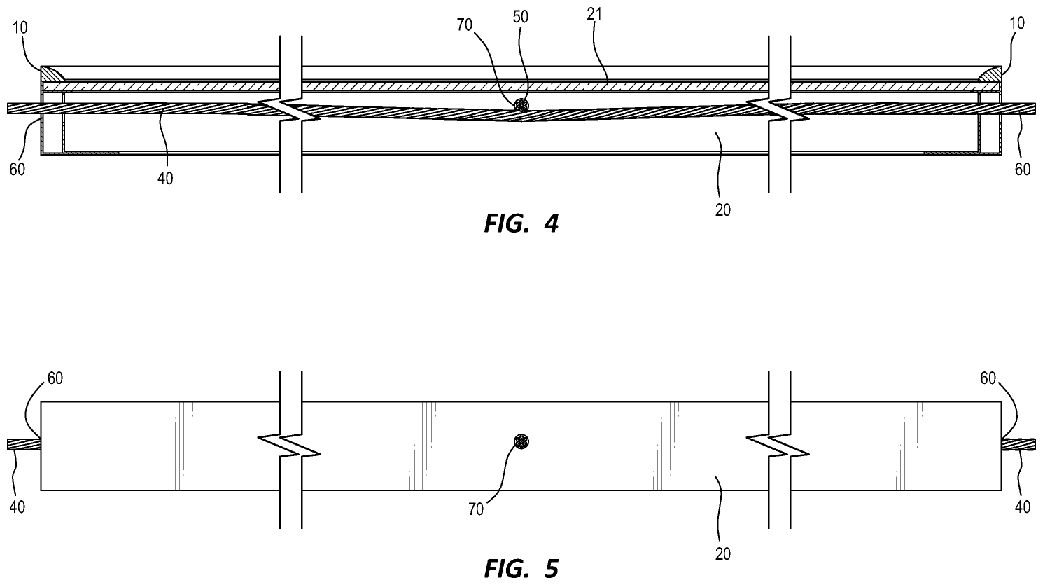

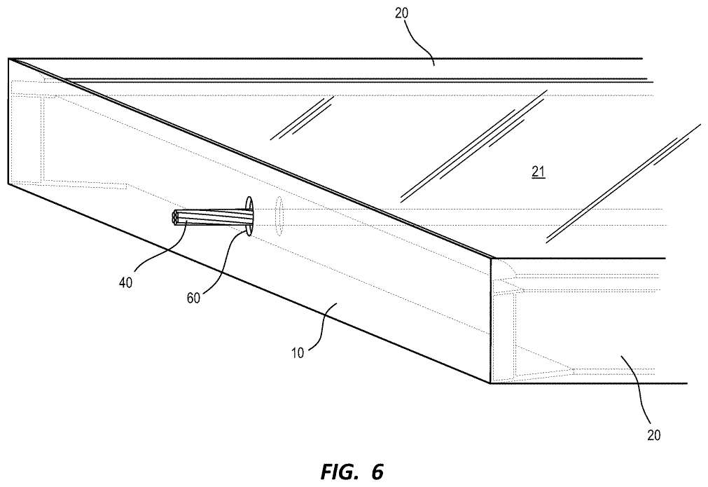

FIG. 4 shows a side view of PV module 4 viewing long-side 20 and long-side penetration 70. FIG. 4 also shows long root cable 40 extending from short-side 10 of PV module 4 through short-side penetration 60. FIG. 5 is a similar cross-section to that of FIG. 3 except it shows an entire PV module 4 with short-side 10, long root cable 40, and substrate 21. Again, it shows short root cable 50 in cross-section.

FIG. 6 shows another view of short-side 10 of PV module 4. Long-side 20 and substrate 21 are shown, as is long root cable 40 extending out from short-side penetration 60. Long root cable 40 extends the entire length of the PV module array, but in FIG. 6 is shown ending outside the edge of PV module 4.

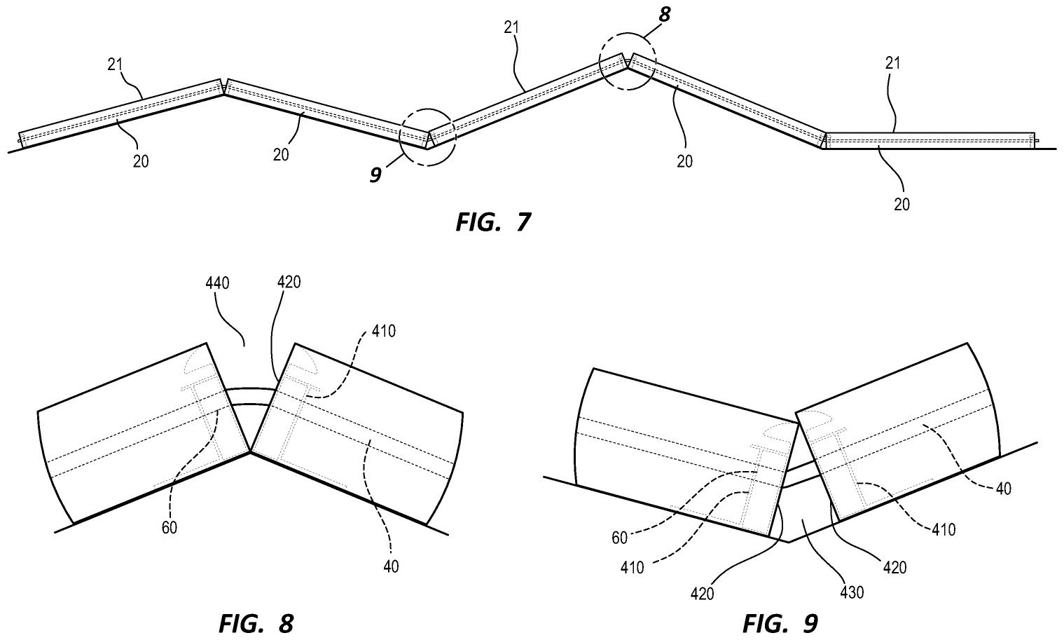

FIG. 7 is a side view of several PV modules from a row of PV modules. In this figure, the view is directly at long-side 20. FIG. 8 shows a magnified view of a joint or abutment of 2 PV modules 4 having lower gap 430. FIG. 8 shows a magnified view of FIG. 7 like that of FIG. 8 but having upper gap 440. Both FIG. 8 and FIG. 9 shows the walls or module sides: inner wall 410 and outer wall 420. FIG. 7, FIG. 8, and FIG. 9 depict the modules shown sitting on a non-flat, earth or ground surface and illustrate the ability of root cables 39 to accommodate adjacent PV modules 4 sitting at different angles. As shown, despite adjacent panels sitting at different angles, long root cable 40 retains the top edge of each panel or the top surface of each panel at substantially the same height or position. In some exemplars, long root cable 40 or short root cable 50 maintain the height of the modules close enough to each other to allow an autonomous robotic cleaning system to operate on the array. In some exemplars, long root cable 40 and short root cable 50 maintain the height of adjacent modules within 1, 2, or 3 inches of each other.

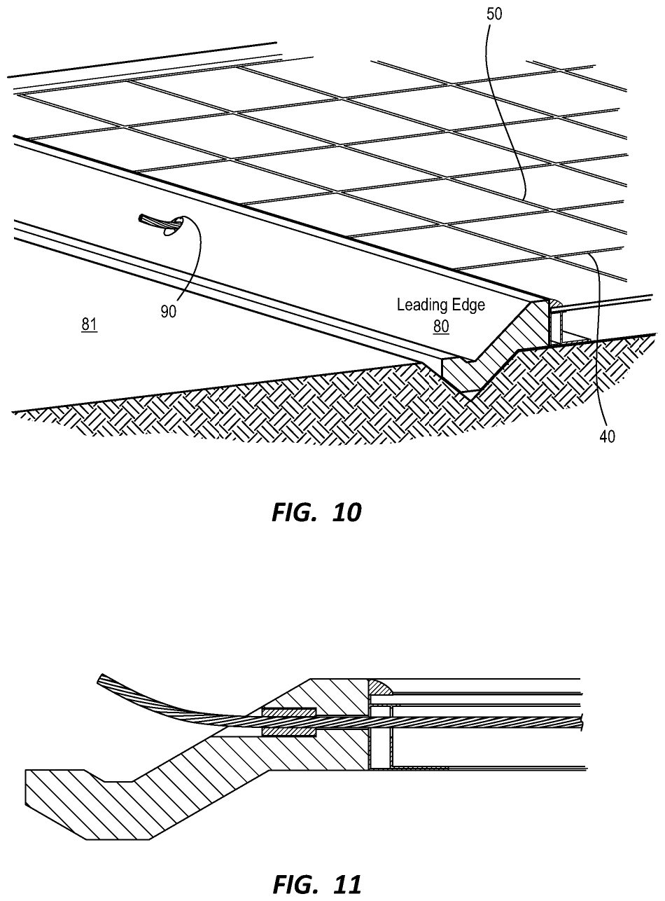

FIG. 10 depicts a schematic view of a portion of a PV array terminating at leading edge 80. Leading edge 80 sits on or in a trench in the earth or ground 81 and, in some PV arrays, serves as the array's outer edge. FIG. 10 shows penetration 90 through leading edge 80 that accommodates long root cable 40 or short root cable 50. Note that the PV modules have been omitted from FIG. 10 for clarity. The interior of the array shows only cables 39. Depending upon the exemplar, cables 39 are mechanically terminated at leading edge 80 or extend past leading edge 80 and terminate at anchors or other hold-downs (not shown) that connect into the ground or another foundation.

FIG. 11 shows leading edge 80 of FIG. 10, in cross-section in this figure. Leading edge 80 is in cross-section, showing leading-edge penetration 90 with PV module 4 butted against leading edge 80 looking at a side view toward long-side 20 with short-side 10 in cross-section.

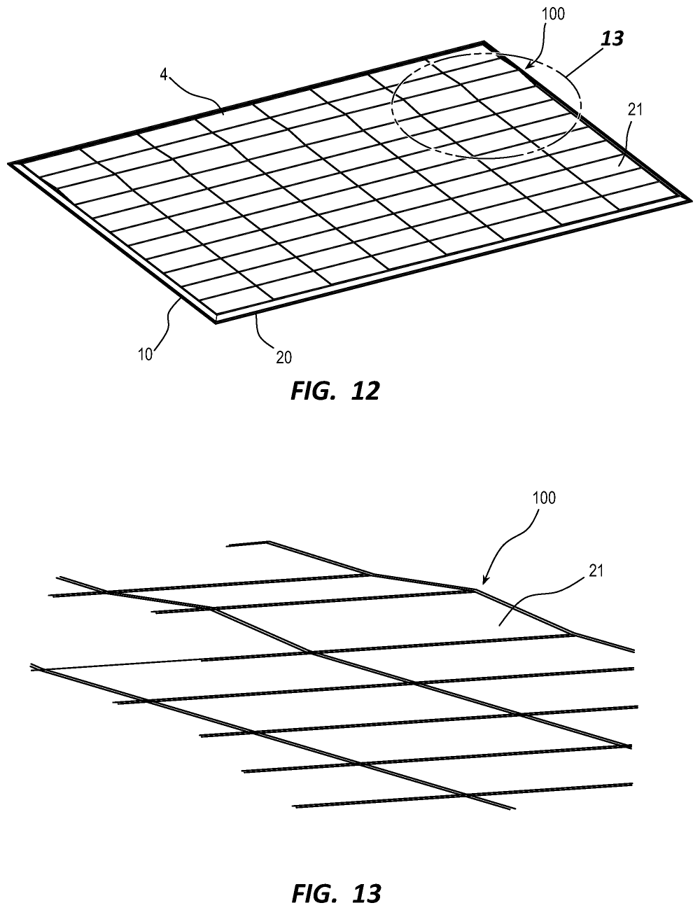

FIG. 12 shows an 11×8 array of PV modules 4 showing short-side 10, long-side 20, and substrate 21. FIG. 12 illustrates a variation in the grade of the Earth or ground at 100, which demonstrates that arrays constructed with root cables can handle slight variations in elevation, whether naturally caused or deliberate. In some exemplars, these variations in grade change the slope of substrate 21, which can increase energy gain. FIG. 13 shows a magnified view of the array of FIG. 12.

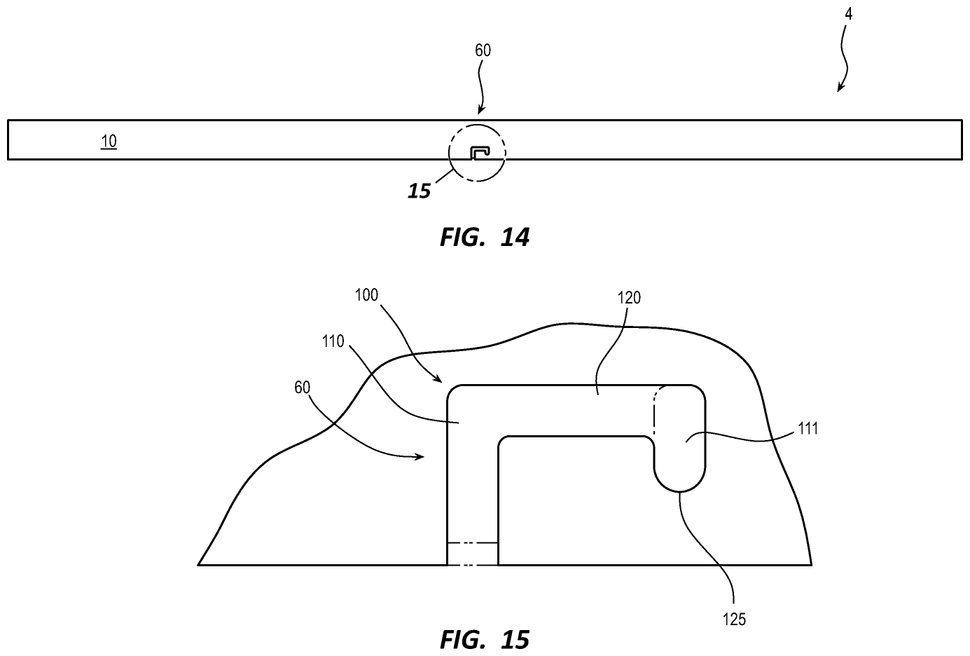

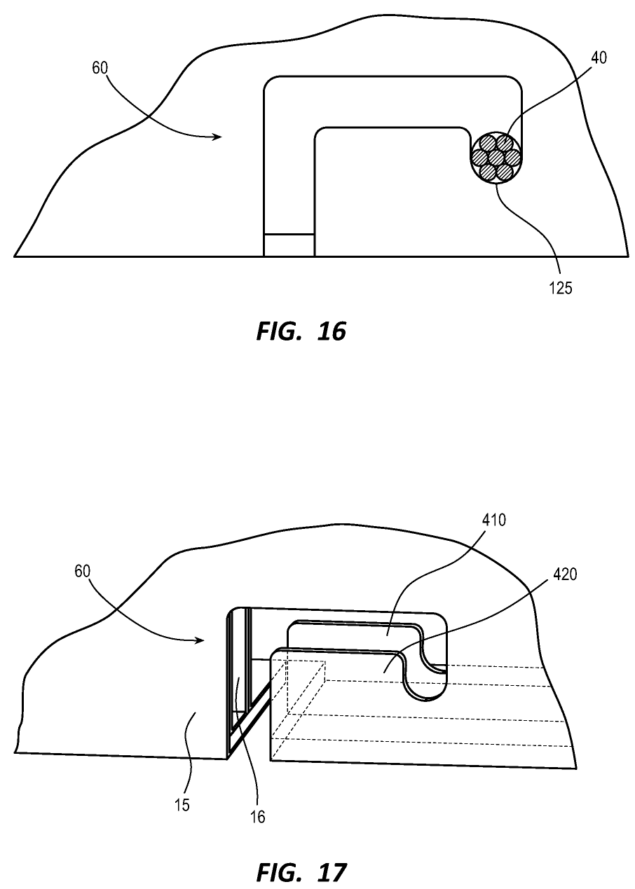

FIG. 14 shows a side view of PV module 4 viewing short-side 10. In this exemplar, PV module 4 has an alternate version of short-side penetration 60. Although the figure shows the alternative version of short-side penetration 60, exemplars exist in which the alternative version can replace long-side penetration 70. Also, some exemplars have alternative versions of short-side penetration 60 and long-side penetration 70. FIG. 15 shows a magnified view of short-side penetration 60 comprising the keyhole slot or groove 101.

Some module versions have openings in the module frame 9, in the module edges 15. These openings are root cable penetrations 59 to receive root cables 39. In some versions, module frame 10 has an inner edge 16. Root cable penetration 59 extends through module edge 15 and inner edge 16 in the versions with an inner edge 16.

In some exemplars, root cable penetration 59 takes the shape of keyhole slot 100. Keyhole slot 100 has several components or regions, including outer vertical slot 110, connected to inner vertical slot 111 by horizontal slot 120. Inner vertical slot 111 has root cable stop 125 at the bottom of inner vertical slot 111.

In some versions, tab 130 extends outward from the side of module frame 9, which can create a desired inter-module spacing.

In some versions of the module, the module edges are constructed from a nonconductive material. Examples of useful nonconductive materials include outdoor-grade plastics and fiber-reinforced composite materials such as fiber-reinforced plastics. Some versions use frames or edges selected from materials including any one or any rational combination of these materials: hard rubber, polymerics, polyolefins, and reinforced polymeric or polyolefin materials (e.g., reinforced by materials such as glass or carbon fibers), composite glass or carbon-filled polymeric materials, particularly including composite glass or carbon-filled polyimide materials and composite glass or carbon-filled polybutylene terephthalate (PBT) materials. Any structural grade polymer material can be used for these edges, including materials rated for outdoor use, UV exposure, etc.

Non-metal materials may eliminate or reduce PV mount grounding or bonding requirements as the non-electricity generating conductive parts are eliminated and thereby do not require grounding per the National Electric code. The module edge material may be formed by injection molding, structural foam molding, compression molding, thermoforming, or three-dimensional printing fabrication using lightweight materials.

The root cable creates a flexible mechanical connection between adjacent solar modules making up a larger array. This results in a meshed array where every solar module is directly or indirectly connected to all other modules in the array through the wire rope network. The arrangement creates an array interior with no parts or pieces to penetrate the Earth's surface in some exemplars. The nature and location of alignment holes in the frame allow the system to align the faces of a solar module with its surrounding modules. The interconnected mesh network resists uplift forces through the combined weight of the solar array and its leading edge resulting in a flexible and abatable anchoring system, the alignment of the faces, and the close proximity to finished grade. This flexible and adaptable anchoring system can resist any localized uplift on any location within the solar array by collectively using the strength of the entire array of solar modules. Flexible mechanical connections enable the array to follow the Earth's natural contour. Wire rope is hidden beneath solar panels and therefore is primarily hidden from direct sunlight and its associated life-shortening effects on components.

Some versions of the wire rope are non-metallic rope or strapping, such as those made from Kevlar Rope, Polypropylene, Nylon, and Carbon Fiber.

FIG. 9 shows PV module 4 with long root cable 40 passing through bushing 910. Bushing 910 has a ridge or head 915 with a diameter greater than body 916 of bushing 910. Bushing 910 receives root cables, such as long root cable 40 and short root cable 50, through entry 931 of head 915, in some array exemplars. Therefore, bushing 910 extends through short-side penetration 60 or long-side penetration 70 in array versions using bushings 910. In some versions, head 915 serves as entry 931 for root cable 39. In this arrangement, head 915 sits on outer wall 420 of PV frame 9 and, across PV module 4 from entry 931, head 915 sits against inner wall 410 such that entry 931 points toward the incoming root cable 39.

In some array versions, adjacent PV modules 4 are spaced apart by a spacer such as an O-ring, bushing, or other spacer types. In some versions using bushings 910, head 915 has a thickness adequate to provide such spacing. In some exemplars, head 915 has a longitudinal thickness equal to the desired spacing, such as the thickness of an O-ring or other spacer.

In some array versions, instead of cables 39 sitting in rows and columns, root cables are run diagonally across the array. In such an arrangement, instead of the cable crossing the panel by entering the first side and exiting an opposite side, root cable 39 enters a side. It exits the module through a penetration on an adjacent side. Such an arrangement may be facilitated by having an open penetration in the PV module sides or having an elongated closed penetration in the PV module sides. A diagonal arrangement could decrease the cable needed for a particular array. In some exemplars, the PV array may be prepared with root cables 39 only bridging PV modules in a row or column direction instead of both. In some versions, root cables may extend from one array to an adjacent array instead of terminating at the edge of an array.

In some versions, PV modules are assembled onto the root cable in a factory or off-site. Then they are rolled or folded into a unit for transportation to the site. In such versions, a PV module row, column, or array may be formed by unrolling or unfolding the unit, placing the row, column, or array at one time instead of sequentially. Such unitization may be accomplished with module-to-module interconnections other than a root cable. For example, hinged connections between the modules could facilitate similar unitization. In some array versions, root cables 39 anchor at one or both ends or anchor to the ground along the cable other than at its ends. In some versions, cables 39 passes over the surface of PV modules with module frames or in frameless PV modules.

The long-side and short-side penetrations can be made anywhere along the long-side or short-side, such as the middle or offset from the middle. In some versions, modules have tabs extending past a module edge, and the cable penetrations are in the tab. In arrays using modules with such tabs, root cables 39 may lie between modules. In array versions with root cables 39 extending over the surface of the modules, the modules may have a tab extending upward past the module face. In some of these versions, the root cable penetration may sit in the upward-extending tab. In some array versions, modules have tabs extending downward from the module or the module frame, and in some of these versions, the root cable penetration may sit in the downward-extending tab. Frameless modules may have downward or outward extending tabs containing root cable penetrations. Upward tabs and downward tabs may have open penetrations and closed penetrations. Tabs extending horizontally or vertically from modules can sit symmetrically or asymmetrically along module edges. In some array versions, modules attach to root cable 39 with a clip instead of or besides using module frame penetrations. For instance, the module substrate may connect to a vertical clip that engages with the root cable. For instance, the hook part of a threaded hook may engage around root cable 39 and extend through a component of the PV module. Threading a nut onto the end of the threaded hook portion of the clip would lock attach the module to the cable.

A function of root cables 39 is to align rows or columns of PV modules 4 of a PV module array. For this disclosure, a row or a column of PV modules refers to the physical arrangement of the PV module. (This is in counterpoint to a string of PV modules formed by the electrical interconnection between a subset of the array modules without regard to the string modules' electrical connectivity.) Root cables 39 align physical rows and columns of the array. They also align the surfaces of modules adjacent to each other. In some array versions, root cables 39 do not provide a significant balance to uplift forces caused by wind or rain. In some array versions, root cables 39 maintain PV modules 4 against buoyant forces caused by rain or floodwaters. In these or other versions, root cables 39 provide an amount of the forces needed to counteract uplift forces, such as uplift forces caused by wind blowing across the surface of the PV array.

In operation, in rows, columns, or arrays of PV modules using closed, short- or long-side penetrations, a PV module 4 is placed into the array starting a row or call, and the root cable is threaded through penetration on a first side of the module from outside to inside. Next, cable 39 passes through an opposite long-side or short-side penetration from inside to outside. In versions using O-rings or other spacers, the O-ring or spacer is strung onto root cable 39, and the next PV module in the row or column is strung onto root cable 39 following the O-ring. This process continues until the last PV module of the row or column is threaded and placed, leaving the ends of root cable 39 loose, terminated, or connected to the ground anchor. In versions using leading edges, root cable 39 passes through leading-edge penetration 90 and the row or column of PV modules. Root cable 39 passes through leading edges at both ends of a row or column, in some exemplars.

In PV arrays with PV modules having open root cable penetrations, the same procedure as above may be followed. The root cable or an entire row or column can be laid or positioned as desired. PV modules of the row or column may be placed by lowering the module onto the cable to engage cable 39 into keyhole slot 101 by manipulating the PV module or grasping the cable with a tool and lifting or clipping the cable into keyhole slot 101.

A module having PV frame 9 with keyhole slot 101 may be placed into a PV array having root cable 39. This placement comprises vertically lowering the module onto root cable 39 with the module angled such that outer vertical slots 110 on opposing short-side 10 or long-side 20 receive root cable 39 at about the same time. The module is lowered until root cable 39 is at the same level as horizontal slot 120. Then, the module is aligned with root cable 39, which causes root cable 39 to pass horizontally through horizontal slot 120 until it reaches inner vertical slot 111. Upon releasing downward module pressure, the module raises, causing root cable 39 to move downward versus inner vertical slot 111 ending at root cable stop 125. This same manipulation can be performed with a tool that slides between adjacent modules and grasps root cable 39.

The keyhole nature of keyhole slot 100 resists root cable 39 disengagement from the module. Disengagement requires tracking the cable back through the module and keyhole slot opposite the installation path. This tracking may need horizontal space alongside the module. As installed, this horizontal space is occupied by surrounding modules. The likelihood of one edge of the module disengaging is low, and disengaging both edges would require rotating the module opposite of the installation rotation direction, which is not expected to occur randomly.

### SPECIFIC EXEMPLARS

Exemplar 1. A method comprising supplying PV modules having faces; and installing an array of the modules in an earth mount configuration on an earth surface having a contour, wherein the array comprises a root cable disposed following the contour.

Exemplar 2. The method of exemplar 1, wherein the cable maintains a module-to-module edge alignment.

Exemplar 3. The method of exemplar 2, wherein the cable interacts with a module though a module frame or a module clip.

Exemplar 4. The method of exemplar 3, wherein the array comprises a row of greater than 25 or 50 modules.

Exemplar 5. The method of exemplar 4, wherein the array comprises a column of greater than 6, 17, 14, 29, or 50 modules.

Exemplar 6. The method of exemplar 5, wherein module comprises penetrations through a module frame member or a clip attached to the frame member or module substrate.

Exemplar 7. The method of exemplar 6 further comprising stringing a module onto a root cable by passing the root cable through an elliptical penetration.

Exemplar 8. The method of exemplar 6 further comprising stringing a module onto a root cable by passing the root cable through a keyhole-slot-shaped penetration.

Exemplar 9. The method of exemplar 8 further comprising installing the root cable and then installing the module by manipulating the module such that the slot captures the root cable.

Exemplar 10. The method of exemplar 8 further comprising stringing a module onto a root cable by passing the root cable through a keyhole-slot-shaped penetration.

Exemplar 11. The method of exemplar 10, wherein the array comprises a leading edge.

Exemplar 12. The method of exemplar 11, wherein the clip detaches from the module.

Exemplar 13. The method of exemplar 12, wherein the clip comprises a hook.

Exemplar 14. The method of exemplar 13, wherein the root cable maintains module-to-module edge alignment for face-to-face angles of 0 to 30 degrees.

Exemplar 15. The method of exemplar 14, wherein the root cables cover the array area in a row direction, a column direction, a diagonal direction, or a combination of these.

Exemplar 16. The method of exemplar 15, wherein the root cable is anchored at an end of, both ends of, one or more midpoints along, or one or more midpoints along and one or both ends of the root cable.

Exemplar 17. The method of exemplar 10, wherein the clip detaches from the module.

Exemplar 18. The method of exemplar 17, wherein the clip comprises a hook.

Exemplar 19. The method of exemplar 18, wherein the root cable maintains module-to-module edge alignment for face-to-face angles of 0 to 30 degrees.

Exemplar 20. The method of exemplar 19, wherein the root cables cover the array area in a row direction, a column direction, a diagonal direction, or a combination of these.

Exemplar 21. The method of exemplar 20, wherein the root cable is anchored at an end of, both ends of, one or more midpoints along, or one or more midpoints along and one or both ends of the root cable.

Exemplar 22. The method of exemplar 7, wherein the array comprises a leading edge.

Exemplar 23. The method of exemplar 22, wherein the clip detaches from the module.

Exemplar 24. The method of exemplar 23, wherein the clip comprises a hook.

Exemplar 25. The method of exemplar 24, wherein the root cable maintains module-to-module edge alignment for face-to-face angles of 0 to 30 degrees.

Exemplar 26. The method of exemplar 25, wherein the root cables cover the array area in a row direction, a column direction, a diagonal direction, or a combination of these.

Exemplar 27. The method of exemplar 26, wherein the root cable is anchored at an end of, both ends of, one or more midpoints along, or one or more midpoints along and one or both ends of the root cable.

Exemplar 28. The method of exemplar 7, wherein the clip detaches from the module.

Exemplar 29. The method of exemplar 28, wherein the clip comprises a hook.

Exemplar 30. The method of exemplar 29, wherein the root cable maintains module-to-module edge alignment for face-to-face angles of 0 to 30 degrees.

Exemplar 31. The method of exemplar 30, wherein the root cables cover the array area in a row direction, a column direction, a diagonal direction, or a combination of these.

Exemplar 32. The method of exemplar 31, wherein the root cable is anchored at an end of, both ends of, one or more midpoints along, or one or more midpoints along and one or both ends of the root cable.

Exemplar 33. The method of exemplar 2, wherein the root cable is anchored at an end of, both ends of, one or more midpoints along, or one or more midpoints along and one or both ends of the root cable.

Exemplar 34. The method of exemplar 33, wherein the clip detaches from the module.

Exemplar 35. The method of exemplar 34, wherein the clip detaches from the module.

Exemplar 36. The method of exemplar 35, wherein the clip comprises a hook.

Exemplar 37. The method of exemplar 36, wherein the root cable maintains module-to-module edge alignment for face-to-face angles of 0 to 30 degrees.

Exemplar 38. The method of exemplar 37, wherein the root cables cover the array area in a row direction, a column direction, a diagonal direction, or a combination of these.

Exemplar 39. The method of exemplar 38, wherein the root cable is anchored at an end of, both ends of, one or more midpoints along, or one or more midpoints along and one or both ends of the root cable.

Exemplar 40. The method of exemplar 39, wherein the array comprises a row of greater than 25 or 50 modules.

Exemplar 41. The method of exemplar 40, wherein the array comprises a column of greater than 6, 17, 14, 29, or 50 modules.

Exemplar 42. The method of exemplar 7, wherein the clip detaches from the module.

Exemplar 43. The method of exemplar 42, wherein the clip comprises a hook.

Exemplar 44. The method of exemplar 43, wherein the root cable maintains module-to-module edge alignment for face-to-face angles of 0 to 30 degrees.

Exemplar 45. The method of exemplar 44, wherein the root cables cover the array area in a row direction, a column direction, a diagonal direction, or a combination of these.

Exemplar 46. The method of exemplar 45, wherein the root cable is anchored at an end of, both ends of, one or more midpoints along, or one or more midpoints along and one or both ends of the root cable.

Exemplar 47. The method of exemplar 46, wherein the array comprises a row of greater than 25 or 50 modules.

Exemplar 48. The method of exemplar 47, wherein the array comprises a column of greater than 6, 17, 14, 29, or 50 modules.

Exemplar 49. The method of exemplar 2, wherein the cable passes under more than 3 modules.

Exemplar 50. The method of exemplar 49, wherein the cable passes beside more than 3 modules.

Exemplar 51. The method of exemplar 50, wherein the root cables cover the array area in a row direction, a column direction, a diagonal direction, or a combination of these.

Exemplar 52. The method of exemplar 51, wherein the cable interacts with a module though a module clip.

Exemplar 53. The method of exemplar 52, wherein the array comprises a leading edge.

Exemplar 54. The method of exemplar 53, wherein the clip detaches from the module.

Exemplar 55. The method of exemplar 54, wherein the clip comprises a hook.

Exemplar 56. The method of exemplar 55, wherein the root cable maintains module-to-module edge alignment for face-to-face angles of 0 to 30 degrees.

Exemplar 57. The method of exemplar 56, wherein the root cables cover the array area in a row direction, a column direction, a diagonal direction, or a combination of these.

Exemplar 58. The method of exemplar 57, wherein the root cable is anchored at an end of, both ends of, one or more midpoints along, or one or more midpoints along and one or both ends of the root cable.

Exemplar 59. The method of exemplar 58, wherein the array comprises a row of greater than 25 or 50 modules.

Exemplar 60. The method of exemplar 52, wherein the array comprises a column of greater than 6, 17, 14, 29, or 50 modules.

Exemplar 61. The method of exemplar 60, wherein the clip detaches from the module.

Exemplar 62. The method of exemplar 61, wherein the clip comprises a hook.

Exemplar 63. The method of exemplar 62, wherein the root cable maintains module-to-module edge alignment for face-to-face angles of 0 to 30 degrees.

Exemplar 64. The method of exemplar 63, wherein the array comprises a row of greater than 25 or 50 modules.

Exemplar 65. The method of exemplar 64, wherein the array comprises a column of greater than 6, 17, 14, 29, or 50 modules.

Exemplar 66. The method of exemplar 1, wherein the array comprises a column of greater than 6, 17, 14, 29, or 50 modules.

Exemplar 67. The method of exemplar 66, wherein the array comprises a row of greater than 25 or 50 modules.

Exemplar 68. The method of exemplar 67, wherein the array comprises a column of greater than 6, 17, 14, 29, or 50 modules.

Exemplar 69. The method of exemplar 68, wherein module comprises penetrations through a module frame member or a clip attached to the frame member or module substrate.

Exemplar 70. The method of exemplar 69 further comprising stringing a module onto a root cable by passing the root cable through an elliptical penetration.

Exemplar 71. The method of exemplar 70 further comprising stringing a module onto a root cable by passing the root cable through a keyhole-slot-shaped penetration.

Exemplar 72. The method of exemplar 71 further comprising installing the root cable and then installing the module by manipulating the module such that the slot captures the root cable.

Exemplar 73. The method of exemplar 72 further comprising stringing a module onto a root cable by passing the root cable through a keyhole-slot-shaped penetration.

Exemplar 74. The method of exemplar 73, wherein the array comprises a leading edge.

Exemplar 75. The method of exemplar 74, wherein the clip detaches from the module.

Exemplar 76. The method of exemplar 75, wherein the clip comprises a hook.

Exemplar 77. The method of exemplar 76, wherein the root cable maintains module-to-module edge alignment for face-to-face angles of 0 to 30 degrees.

Exemplar 78. The method of exemplar 77, wherein the root cables cover the array area in a row direction, a column direction, a diagonal direction, or a combination of these.

Exemplar 79. The method of exemplar 78, wherein the root cable is anchored at an end of, both ends of, one or more midpoints along, or one or more midpoints along and one or both ends of the root cable.

Exemplar 80. The method of exemplar 73, wherein the clip detaches from the module.

Exemplar 81. The method of exemplar 80, wherein the clip comprises a hook.

Exemplar 82. The method of exemplar 81, wherein the root cable maintains module-to-module edge alignment for face-to-face angles of 0 to 30 degrees.

Exemplar 83. The method of exemplar 82, wherein the root cables cover the array area in a row direction, a column direction, a diagonal direction, or a combination of these.

Exemplar 84. The method of exemplar 83, wherein the root cable is anchored at an end of, both ends of, one or more midpoints along, or one or more midpoints along and one or both ends of the root cable.

Exemplar 85. The method of exemplar 70, wherein the array comprises a leading edge.

Exemplar 86. The method of exemplar 85, wherein the clip detaches from the module.

Exemplar 87. The method of exemplar 86, wherein the clip comprises a hook.

Exemplar 88. The method of exemplar 87, wherein the root cable maintains module-to-module edge alignment for face-to-face angles of 0 to 30 degrees.

Exemplar 89. The method of exemplar 88, wherein the root cables cover the array area in a row direction, a column direction, a diagonal direction, or a combination of these.

Exemplar 90. The method of exemplar 89, wherein the root cable is anchored at an end of, both ends of, one or more midpoints along, or one or more midpoints along and one or both ends of the root cable.

Exemplar 91. The method of exemplar 70, wherein the clip detaches from the module.

Exemplar 92. The method of exemplar 91, wherein the clip comprises a hook.

Exemplar 93. The method of exemplar 92, wherein the root cable maintains module-to-module edge alignment for face-to-face angles of 0 to 30 degrees.

Exemplar 94. The method of exemplar 93, wherein the root cables cover the array area in a row direction, a column direction, a diagonal direction, or a combination of these.

Exemplar 95. The method of exemplar 94, wherein the root cable is anchored at an end of, both ends of, one or more midpoints along, or one or more midpoints along and one or both ends of the root cable.

Exemplar 96. The method of exemplar 64, wherein the root cable is anchored at an end of, both ends of, one or more midpoints along, or one or more midpoints along and one or both ends of the root cable.

Exemplar 97. The method of exemplar 96, wherein the array comprises a leading edge.

Exemplar 98. The method of exemplar 97, wherein the clip detaches from the module.

Exemplar 99. The method of exemplar 98, wherein the clip comprises a hook.

Exemplar 100. The method of exemplar 99, wherein the root cable maintains module-to-module edge alignment for face-to-face angles of 0 to 30 degrees.

Exemplar 101. The method of exemplar 100, wherein the root cables cover the array area in a row direction, a column direction, a diagonal direction, or a combination of these.

Exemplar 102. The method of exemplar 101, wherein the root cable is anchored at an end of, both ends of, one or more midpoints along, or one or more midpoints along and one or both ends of the root cable.

Exemplar 103. The method of exemplar 102, wherein the array comprises a row of greater than 25 or 50 modules.

Exemplar 104. The method of exemplar 103, wherein the array comprises a column of greater than 6, 17, 14, 29, or 50 modules.

Exemplar 105. The method of exemplar 104, wherein the clip detaches from the module.

Exemplar 106. The method of exemplar 105, wherein the clip comprises a hook.

Exemplar 107. The method of exemplar 106, wherein the root cable maintains module-to-module edge alignment for face-to-face angles of 0 to 30 degrees.

Exemplar 108. The method of exemplar 107, wherein the root cables cover the array area in a row direction, a column direction, a diagonal direction, or a combination of these.

Exemplar 109. The method of exemplar 108, wherein the root cable is anchored at an end of, both ends of, one or more midpoints along, or one or more midpoints along and one or both ends of the root cable.

Exemplar 110. The method of exemplar 109, wherein the array comprises a row of greater than 25 or 50 modules.

Exemplar 111. The method of exemplar 110, wherein the array comprises a column of greater than 6, 17, 14, 29, or 50 modules.

Exemplar 112. The method of exemplar 64, wherein the cable passes under more than 3 modules.

Exemplar 113. The method of exemplar 112, wherein the cable passes beside more than 3 modules.

Exemplar 114. The method of exemplar 113, wherein the root cables cover the array area in a row direction, a column direction, a diagonal direction, or a combination of these.

Exemplar 115. The method of exemplar 114, wherein the cable interacts with a module though a module clip.

Exemplar 116. The method of exemplar 115, wherein the array comprises a leading edge.

Exemplar 117. The method of exemplar 116, wherein the clip detaches from the module.

Exemplar 118. The method of exemplar 117, wherein the clip comprises a hook.

Exemplar 119. The method of exemplar 118, wherein the root cable maintains module-to-module edge alignment for face-to-face angles of 0 to 30 degrees.

Exemplar 120. The method of exemplar 119, wherein the root cables cover the array area in a row direction, a column direction, a diagonal direction, or a combination of these.

Exemplar 121. The method of exemplar 120, wherein the root cable is anchored at an end of, both ends of, one or more midpoints along, or one or more midpoints along and one or both ends of the root cable.

Exemplar 122. The method of exemplar 121, wherein the array comprises a row of greater than 25 or 50 modules.

Exemplar 123. The method of exemplar 122, wherein the array comprises a column of greater than 6, 17, 14, 29, or 50 modules.

Exemplar 124. The method of exemplar 123, wherein the clip detaches from the module.

Exemplar 125. The method of exemplar 124, wherein the clip comprises a hook.

Exemplar 126. The method of exemplar 125, wherein the root cable maintains module-to-module edge alignment for face-to-face angles of 0 to 30 degrees.

Exemplar 127. The method of exemplar 126, wherein the array comprises a row of greater than 25 or 50 modules.

Exemplar 128. The method of exemplar 127, wherein the array comprises a column of greater than 6, 17, 14, 29, or 50 modules.

Exemplar 129. The method of exemplar 128, wherein the array comprises a row of greater than 25 or 50 modules.

1. A method comprising:
supplying PV modules having faces;
and
installing an array of the modules in an earth mount configuration on an earth surface having a contour,
wherein the array comprises a root cable disposed following the contour.

2. The method of claim 1, wherein the cable maintains a module-to-module edge alignment.

3. The method of claim 2, wherein the cable interacts with a module though a module frame or a module clip.

4. The method of claim 3, wherein the array comprises a row of greater than 25 or 50 modules.

5. The method of claim 4, wherein the array comprises a column of greater than 6, 17, 14, 29, or 50 modules.

6. The method of claim 5, wherein module comprises penetrations through a module frame member or a clip attached to the frame member or module substrate.

7. The method of claim 6 further comprising stringing a module onto a root cable by passing the root cable through an elliptical penetration.

8. The method of claim 6 further comprising stringing a module onto a root cable by passing the root cable through a keyhole-slot-shaped penetration.

9. The method of claim 8 further comprising installing the root cable and then installing the module by manipulating the module such that the slot captures the root cable.

10. The method of claim 8 further comprising installing the root cable and then installing the module by grabbing the root cable with a tool and lifting the root cable into the slot and seating the root cable in the slot.

11. The method of claim 10, wherein the array comprises a leading edge.

12. The method of claim 11, wherein the clip detaches from the module.

13. The method of claim 12, wherein the clip comprises a hook.

14. The method of claim 13, wherein the root cable maintains module-to-module edge alignment for face-to-face angles of 0 to 30 degrees.

15. The method of claim 14, wherein the root cables cover the array area in a row direction, a column direction, a diagonal direction, or a combination of these.

16. The method of claim 15, wherein the root cable is anchored at an end of, both ends of, one or more midpoints along, or one or more midpoints along and one or both ends of the root cable.

17. The method of claim 2, wherein the root cable is anchored at an end of, both ends of, one or more midpoints along, or one or more midpoints along and one or both ends of the root cable.

18. The method of claim 17, wherein the root cables cover the array area in a row direction, a column direction, a diagonal direction, or a combination of these.

19. The method of claim 18 further comprising stringing a module onto a root cable by passing the root cable through an elliptical penetration.

20. The method of claim 18 further comprising installing the root cable and then installing the module by grabbing the root cable with a tool and lifting the root cable into a keyhole-slot-shaped penetration and seating the root cable in the penetration.
